(19) United States
(12) Patent Application Publication
(10) Pub. No.: US 2020/0116052 A1
(43) Pub. Date: Apr. 16, 2020

(54) Transmission Oil Filter Assembly

(71) Applicant: FORD GLOBAL TECHNOLOGIES, LLC, Dearborn, MI (US)

(72) Inventors: Lev PEKARSKY, West Bloomfield, MI (US); Vladimir YASNOGORODSKIY, Sterling Heights, MI (US); Akhter ZAMAN, Novi, MI (US)

(21) Appl. No.: 16/706,156

(22) Filed: Dec. 6, 2019

Related U.S. Application Data
(63) Continuation of application No. 15/075,798, filed on Mar. 21, 2016.

(51) Int. Cl. F01M 11/03; F01M 11/00; F16H 57/04; B01D 35/14; B01D 35/00; B01D 29/00; B01D 29/01; B01D 29/90

(52) U.S. Cl. CPC F01M 11/03; F01M 11/0004; F16H 57/0404; B01D 35/14; B01D 35/005; B01D 29/0093; B01D 29/016; B01D 29/0004; B01D 29/90; F01M 2011/0029; B01D 2201/4092; B01D 29/0095; B01D 29/0018; B01D 29/01

(57) ABSTRACT

A transmission oil filter is assembled from a filter element, a base, and a cover. Each of the three pieces extends beyond the filtration media to form an inlet channel. The inlet channel is low enough to fit under a valve body. Placing the inlet in this channel ensures that the inlet draws transmission fluid at road gradients and acceleration rates at which an inlet under the filtration media would draw air.

### REFERENCE TO RELATED APPLICATIONS

This application is a continuation of U.S. application Ser. No. 15/075,798 filed Mar. 22, 2016, the disclosure of which is hereby incorporated in its entirety by reference herein.

### TECHNICAL FIELD

This disclosure relates to the field of transmission systems. More particularly, the disclosure pertains to a filter assembly.

### BACKGROUND

Automatic transmission fluid serves many functions in a modern automatic transmission. Pressurized fluid may be used to engage friction clutches in order to establish a power flow path with a desired speed ratio. Fluid lubricates gears and bearings. Excess heat is removed by fluid flowing over various components. When the fluid contains contaminants, it may be less effective in these functions and may cause failures such as stuck valves. Therefore, transmissions often include fluid filters.

Filters may be placed on either the inlet (low pressure) side of a transmission pump or on the outlet (high pressure) side of a transmission pump. Transmission oil filters typically contain a filtration media. The media may be pleated to increase the surface area in a limited space.

### SUMMARY OF THE DISCLOSURE

A transmission includes a filter element, a filter cover, and a filter base. The filter element has a filtration portion and an extension. The filtration portion has side walls defining a top edge and supporting filtration media. The extension is joined to the filtration portion below the filtration media. The filtration portion and the extension define an element bottom edge. A height of the extension may be less than a distance between the filter element bottom edge and a top of the filtration media. The filter cover is in contact with the top edge. The filter cover defines a filter outlet adjacent to the filtration portion. The filter cover also defines a bottom cover edge. The filter base defines a filter inlet adjacent to the extension. The filter base is sealed against the element bottom edge and the cover bottom edge, for example by a single continuous weld. An interior height of the cover may be equal to a distance between the filter element top edge and the filter element bottom edge such that the filter element bottom edge and the cover bottom edge are coplanar. A valve body may extend over the inlet and extend lower than the top edge or lower that a top of the filtration media. The transmission may be filled with transmission fluid such that, when the transmission is inclined, the inlet is below the fluid surface and the filter base adjacent to the filtration portion is above the fluid surface.

A transmission filter is assembled by placing a cover over an element and joining a base to bottom edges of the cover and of the element with a continuous sealing joint. The cover is placed over the element such that a surface of the cover defining an outlet contacts a top edge of the element to align the bottom edge of the element with a bottom edge of the cover. The element has filtration media extending a first distance above the element bottom edge. The element has an extension with a height relative to the element bottom edge less than the first distance. The base defines an inlet adjacent to the extension.

### BRIEF DESCRIPTION OF THE DRAWINGS

FIG. 1 is a schematic diagram of a vehicle transmission.

FIG. 2 is a cross section of a first oil filter in a transmission sump.

FIG. 3 is a cross section of a second oil filter in a transmission sump.

FIG. 4 is a cut-away pictorial view of the second oil filter.

FIG. 5 is an exploded view of the second oil filter.

FIG. 6 is a pictorial view of the second oil filter.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

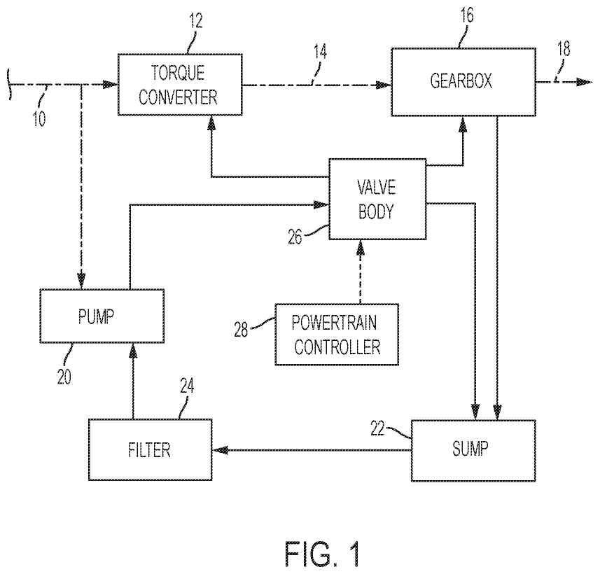

FIG. 1 schematically illustrates a transmission hydraulic system. Dash-dot lines indicate mechanical power flow. Solid lines indicate flow of hydraulic fluid. Dashed lines indicate electrical signals. Transmission input shaft 10 is connected to the vehicle crankshaft. Power from the engine is delivered to torque converter 12 which drives turbine shaft 14. Clutches within gearbox 16 are engaged to establish a power flow path from turbine shaft 14 to output shaft 18. Different power flow paths having different speed ratios may be established by engaging different clutches. In a rear wheel drive transmission, output shaft 18 is connected to a driveshaft which transmits the power to a rear differential and then to rear wheels. In a four wheel drive vehicle, a transfer case may be installed between the output shaft and the driveshaft to divert a portion of the power to a front differential and then to front wheels. In a front wheel drive vehicle, the output shaft may transmit power to a front differential via gears or a chain.

Some engine power is diverted to drive transmission pump 20. Transmission pump 20 draws fluid from sump 22, through filter 24, and delivers the fluid, at increased pressure, to valve body 26. The pressure at which fluid enters the valve body may be called line pressure. Controller 28 commands a network of control valves within the valve body to deliver fluid to torque converter and gearbox components at desired pressures less than line pressure and at desired flow rates. Fluid drains from the control valves and from the gearbox back into sump 22.

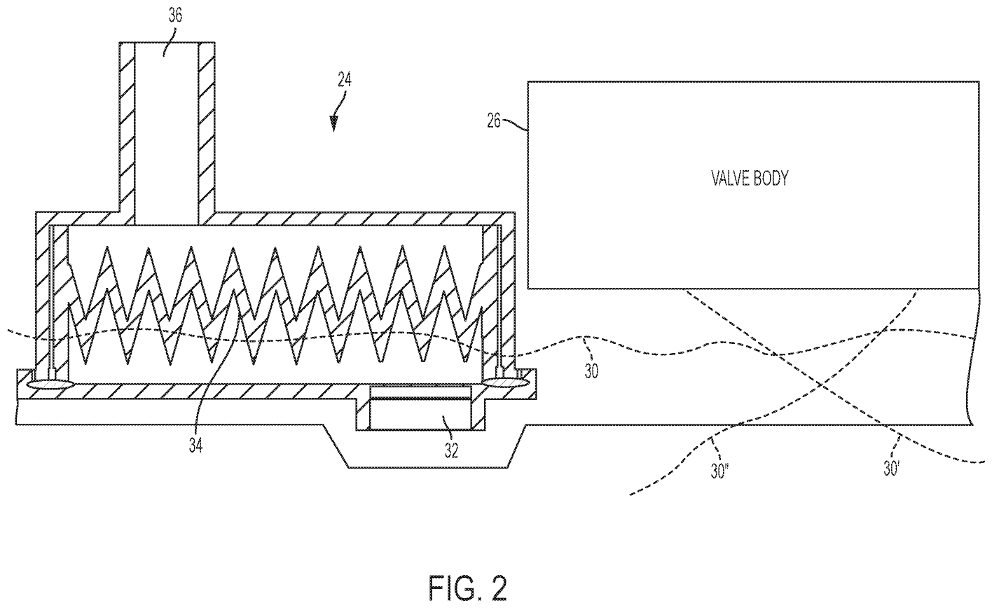

FIG. 2 is a partial cross section of filter 24, valve body 26 and sump 22. When the vehicle is on level ground and either stationary or traveling at constant speed, the top of the fluid in the sump is represented by dotted line 30. Pump 20 draws the fluid through filter inlet 32, through filtration media 34, and through filter outlet 36. The filtration media may be pleated to increase the surface area within the constrained axial distance available. When the vehicle decelerates or is on a downhill incline, the fluid may move forward in the sump such that the top of the fluid follows dotted line 30′. This circumstance does not pose a problem with respect to filter 24. However, when the vehicle accelerates or goes up a hill such that the top of the fluid follows dotted line 30″, the pump may draw air instead of fluid. If this occurs for a brief interval, the air may cause an unpleasant noise. If the situation persists, the transmission may cease to function or become damaged. Moving the filter farther rearward may not be possible due to the space required for the valve body or other transmission components.

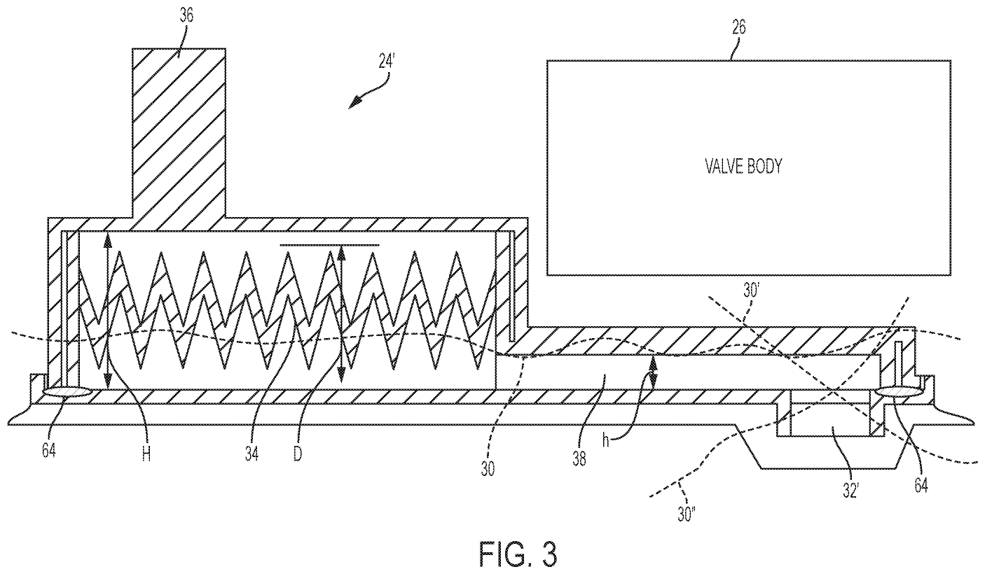

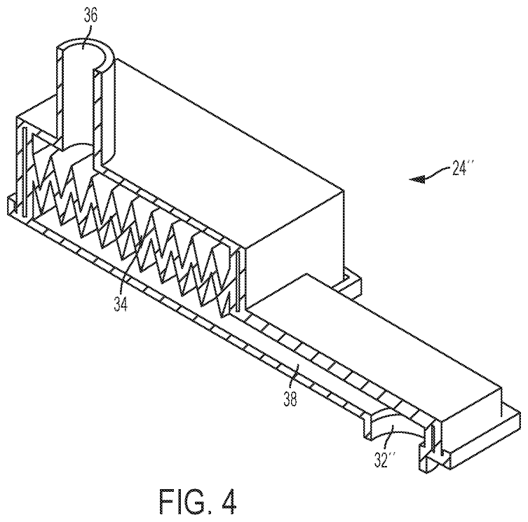

FIGS. 3 and 4 show a revised filter design 24′. Modified filter 24′ includes an extension channel 38. The height h of the extension channel permits packaging the extension underneath the valve body 26. The height h of the extension channel is less than the distance D between the bottom of the filter and the top of the filtration media. Therefore, the filtration media 34 does not extend into the extension channel 38. Inlet 32′ is in the extension channel 38 as opposed to being under the filtration media 34. In this location, inlet 32′ draws fluid regardless of the vehicle acceleration rate or the road incline.

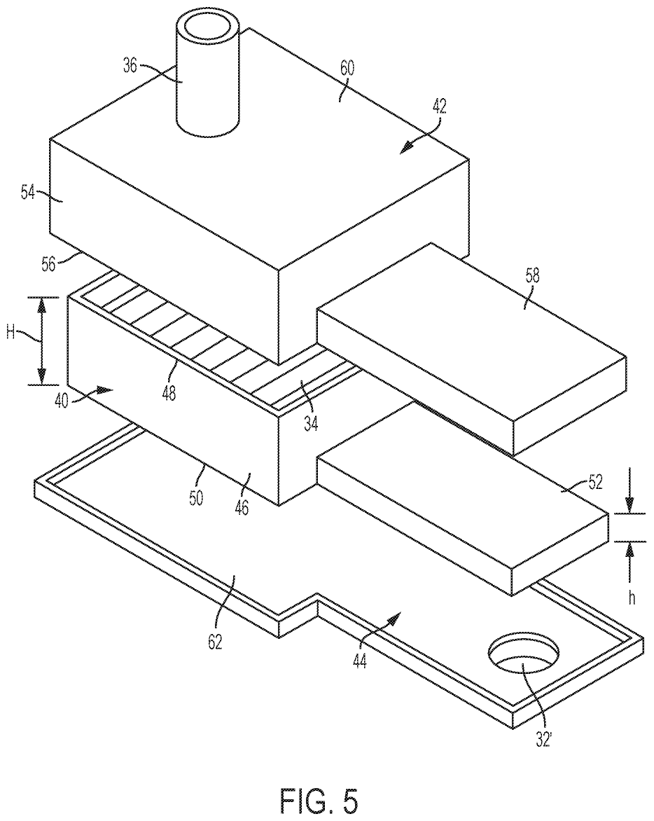

FIG. 5 illustrates a method of assembling filter 24′. The filter is assembled from three parts: a filter element 40, a cover 42, and a base 44. Each of these parts may be made of plastic (except for the filtration media 34). Filter element 40 has side walls 46 that define a top edge 48 and a portion of a bottom edge 50. Top edge 48 and bottom edge 50 are separated by a vertical distance H. The volume surrounded by the side walls is called the filtration portion. The filtration portion is open on both the top and on the bottom. The filtration media 34 is joined to the inner surface of the side walls between the top edge and the bottom edge. An extension 52 extends from one of the side walls below the filtration media. The extension 52 is open on the bottom but closed on the top. The bottom of the extension 52 defines the remainder of the bottom edge of the filter element. The extension 52 has a height h which is less than H.

In a first assembly step, cover 42 is placed over filter element 40. Cover 42 has side walls 54 which partially define a bottom edge 56 and an extension 58 which defines the remainder of the bottom edge 56. The extension 58 is open on the bottom and closed on the top. Outlet channel 36 is formed into the top 60 of the cover. The bottom surface of the top 60 is separated from the bottom edge of the cover 56 by the distance H. Consequently, when the cover is placed over the filter element with the top edge 48 of the filter element in contact with the bottom surface of the top of the cover, the bottom edges 50 and 56 of the filter element and the cover respectively are aligned.

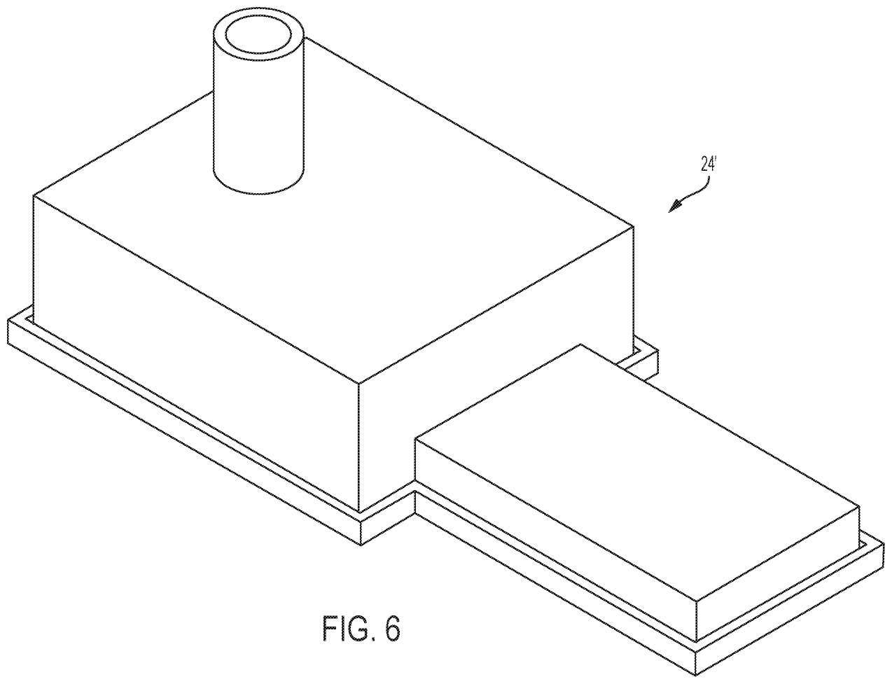

In a second assembly step, the filter element and the cover are placed on the base 44. The bottom edges 50 and 56 of the filter element and the cover respectively fit tightly against the flat top surface 62 of the base. In a third assembly step, heat is applied to a bottom surface of the base opposite the bottom edges 50 and 56 of the filter element and the cover. This heat momentarily melts the plastic. When the plastic re-hardens, the bottom edges of the filter element and the cover become welded to the base. The heat is applied around the full perimeter to form a continuous weld 64 (visible in FIG. 3). In addition to fastening the components, this weld forms a seal which forces any fluid that enters inlet 32′ to flow through filter media 34 before exiting outlet 36. Alternatively, this continuous, sealing joint could be formed by adhesive. The completed filter is shown in FIG. 6.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A transmission filter assembly comprising:
a filter element enclosing a filtration media element inside a plurality of side walls, the side walls defining a top opening with a top edge and defining a bottom opening with a bottom edge;
a filter cover in contact with the top edge of the side walls, the filter cover defining a filter outlet downstream from the filtration media element, the filter cover having a bottom cover edge, wherein the height of the filter element is equal to the distance between an inner surface of the filter cover above the filter media, and an inner surface of the base below the filter media; and
a filter base defining a filter inlet upstream from the filtration media element, wherein the bottom edge of the side walls and the bottom cover edge are attached to the base to define a flow path from the filter inlet through the filtration media element and to the filter outlet, wherein the filter element is held in place by the filter cover engaging the top edge of the filter element to hold the filter element against the base.

2. The transmission filter assembly of claim 1 wherein an interior height of the cover is equal to a distance between the filter element top edge and the filter element bottom edge such that the filter element bottom edge and the cover bottom edge are coplanar when attached to the filter base.

3. The transmission filter assembly of claim 1 further comprising:
a single continuous weld joining the filter base, the filter element, and the filter cover.

4. The transmission filter assembly of claim 1 wherein the filter cover includes an extension connected to a side wall, the filter base including a base extension, wherein the filter inlet is provided in the base extension, wherein the filter cover and the filter base are assembled to define a channel having a height less than a distance between the filter element bottom edge and a top of the filtration media.

5. The transmission filter assembly of claim 4 wherein the base includes a planar upper surface extending from the filter inlet and fully below the filtration media element, wherein the planar upper surface facilitates fluid flow from the fluid inlet to the filtration media element.

6. The transmission filter assembly of claim 5 wherein an inner surface of the extension of the filter cover is parallel to the planar upper surface of the base, and wherein the channel is fully open from the filter inlet to the filtration media with no structure or restriction in the channel.

7. The transmission filter of claim 1 wherein the filtration media element is attached to the side walls of the filter element.

8. A transmission filter assembly comprising:
a filter element enclosing a filtration media element inside a plurality of side walls, the side walls defining a top opening having a top edge and defining a bottom opening having a filter element bottom edge;
a filter cover in contact with the top edge of the side walls, the filter cover defining a filter outlet downstream from the filtration media element, the filter cover having a bottom cover edge; and
a filter base defining a filter inlet upstream from the filtration media element, wherein the filter element bottom edge and the bottom cover edge lie in a common plane when attached to a planar upper surface of the filter base, wherein the bottom edge of the side walls and the bottom cover edge are attached to the base to define a flow path from the filter inlet through the filtration media element and to the filter outlet, wherein the filter element is held in place by the filter cover engaging the top edge of the filter element to hold the filter element against the base.

9. The transmission filter assembly of claim 8 wherein an interior height of the cover is equal to a distance between the filter element top edge and the filter element bottom edge such that the filter element bottom edge and the cover bottom edge are coplanar when attached to the filter base.

10. The transmission filter assembly of claim 8 further comprising:
a single continuous weld joining the filter base, the filter element, and the filter cover.

11. The transmission filter assembly of claim 8 wherein the filter cover includes an extension connected to a side wall, the filter base including a base extension, wherein the filter inlet is provided in the base extension, wherein the filter cover and the filter base are assembled to define a channel having a height less than a distance between the filter element bottom edge and a top of the filtration media.

12. The transmission filter assembly of claim 11 wherein the base includes a planar upper surface extending from the filter inlet and fully below the filtration media element, wherein the planar upper surface facilitates fluid flow from the fluid inlet to the filtration media element.

13. The transmission filter assembly of claim 12 wherein an inner surface of the extension of the filter cover is parallel to the planar upper surface of the base, and wherein the channel is fully open from the filter inlet to the filtration media with no structure or restriction in the channel.

14. The transmission filter of claim 8 wherein the filtration media element is attached to the side walls of the filter element.

15. A method of assembling a transmission fluid filter comprising:
placing a cover having an inner surface defining an outlet over a filtration media element with the inner surface of the cover contacting a top edge of the filtration media element to align a bottom edge of the element with a bottom edge of the cover in a common plane; and
joining a base defining an inlet to the bottom edge of the cover and the bottom edge of element with a continuous, sealing joint.

16. The method of claim 15, wherein the filtration media element having filtration media spaced a first distance above the bottom edge of the filtration media element, further comprising:
an extension defining a channel having a height relative to the filtration media element bottom edge less than the first distance.

17. The method of claim 15 wherein the joining step further comprises:
melting the bottom edge of the element, the bottom edge of the cover, and the base in the same plane to form the continuous, sealing joint.

18. The method of claim 15 wherein the joining step further comprises:
laser welding the bottom edge of the element, the bottom edge of the cover, and the base in the same plane to form the continuous, sealing joint lying in the common plane.
the filtration media element including an extension with
